(19) United States
(12) Patent Application Publication
(10) Pub. No.: US 2025/0182599 A1
(43) Pub. Date: Jun. 5, 2025

(54) System for Automated Real-Time Asset Management

(71) Applicant: AeroCharge Inc., San Diego, CA (US)

(72) Inventors: Marko Vukovic, San Diego, CA (US); Gregory Magruder, San Diego, CA (US); Arash Vafanejad, San Diego, CA (US); Eliezer Ihejirika, San Diego, CA (US); Ho Lyun Jeong, San Diego, CA (US)

(21) Appl. No.: 18/421,701

(22) Filed: Jan. 24, 2024

Related U.S. Application Data
(60) Provisional application No. 63/605,999, filed on Dec. 4, 2023.

(51) Int. Cl. G08B 13/24

(52) U.S. Cl. CPC G08B 13/2462

(57) ABSTRACT

Various embodiments of a method and apparatus for automated real-time asset management are disclosed. In some embodiments, the system includes an association analysis algorithm for associating data collected about itemsets with the itemsets and an algorithm for forecasting changes in the states and statuses of the inventory, allowing for the automation of procurement and other functions of managing inventory. In some embodiments, the tag reader transmits power and communications signals to the tag. In some embodiments, the reader uses a lower frequency and a wider aperture for scanning for tags and a higher frequency and a narrower aperture for communications. In some embodiments, the tags include one or more storage capacitors, to power the tag to respond to the reader across long distances.

### CLAIM OF PRIORITY TO PREVIOUSLY FILED PROVISIONAL APPLICATION-INCORPORATION BY REFERENCE

This non-provisional application claims priority to an earlier-filed provisional application No. 63/605,999 filed Dec. 4, 2023, entitled “System for Automated Real-Time Asset Management” (ATTY DOCKET NO. AERO-002-PROV), and all its contents, are hereby incorporated by reference herein as if set forth in full.

### BACKGROUND

### (1) Technical Field

The disclosed method and apparatus relate generally to systems for tracking and managing assets. In particular, the disclosed method and apparatus relate to a system and method for automated real-time asset tracking and management.

### (2) Background

RFID (Radio Frequency Identifiers) systems are sometimes used for inventory tracking. However, RFID systems have a short range (e.g., about 10 feet). The signals transmitted to and received from the RFIDs can be relayed by other devices forming a network, thus extending the range over which communications are conducted. However, setting up a network to send a message over a network takes time and involves additional hardware. Also, inventory management requires more knowledge about the assets in the inventory than just the locations of each asset.

Accordingly, it would be advantageous to provide a system that can identify a passive tag relatively far from the reader, more fully manage inventory and communicate more efficiently with asset tags that identify devices without extra networking hardware.

### SUMMARY

Various embodiments of a method and apparatus for long-range asset tracking and management are disclosed.

In some embodiments, a system has one or more Long-Range Asset Tag Readers (hereafter referred to as “readers”) that communicate with asset tags (hereafter referred to as “tags”). The readers facilitate tracking and management of assets associated with the tags. The tags may be located relatively far from the reader. In addition, the readers communicate with a tag management module. The tag management module, in turn communicates with an asset management module. The asset management module and the tag management module provide processing capabilities that assist with tracking and managing the assets.

In some embodiments, readers send data signals to be received by any tags that are within range. Typically, such tags require power to be supplied to operate. Therefore, before a tag can receive the data signals, the tag must receive power sent from one or more readers. Power is provided by the reader in the form of an RF (Radio Frequency) power signal that is independent of the data signal. In some embodiments, the power signal is transmitted at a higher frequency using beam forming to focus the energy that is being transmitted to the tag. In some embodiments, a phased array antenna is used to form and dynamically control the directional beam used to transmit the power signal. The dynamic control of the direction of the power signal beam allows energy to be focused over transmit paths between the reader and tags within range. In some embodiments, the tags convert the received RF power signals to DC (Direct Current) power output. The DC power output provides power to the tag electronics and allow the tag to transmit asset data to the reader.

In some embodiments, a power signal is a simple signal transmitted by the reader without modulation (i.e., the power signal carries no data). For example, in some embodiments, the power signal is an unmodulated sinusoidal wave. In some embodiments, the transmit paths between the reader and the tags include line-of-sight transmit paths or reflection paths from objects. In some such embodiments, the readers perform a slow scan from time to time. During such slow scanning, the reader sends the power signal in a manner that dwells on, pauses at, or otherwise provides power to different locations for a period of time sufficient to provide enough power to any tags in the area to allow such receiving tags to acquire sufficient power to operate. Thus, any tags in the area are provided sufficient power to allow the tag to retransmit at least one of the data signals sent by at least one of the readers. In this way, the readers can find tags that respond to the data signals transmitted from the reader. Once the tag has received sufficient power to operate, the tag receives and retransmits a data signal that is sent from the reader. After receiving the retransmitted data signal from the tag, including additional data modulated onto the retransmitted signal, the additional data is provided to an asset database accessible within a cloud. By associating a tag that responds with the direction of the beam, the direction of the beam is used to assist in locating an asset with which the tag is associated. The retransmitted signal is modulated with information that the tag adds to the received data signal prior to retransmission (i.e., the tag acts as an RFID type transponder). In other embodiments, other protocols for indicating to the reader that the tag has detected signals transmitted by the reader are used.

In some embodiments, the reader provides to the asset management module via the tag management module, the asset data received in the retransmitted data signal. In some embodiments, the asset data includes the beam direction at the time the asset data was received by the reader. The asset management module stores the asset data and automates asset procurement policies using predictive analytics and machine learning algorithms. Predictive analytics applies statistical algorithms and machine learning techniques to identify the likelihood of future outcomes based on historical data. This allows predictions and informs decision-making by uncovering patterns, trends, and relationships within the data.

In some embodiments, the tag management module 104 manages a scan schedule that controls the scanning of the power signal. The scan schedule determines when each of the readers will transmit power signals used to find assets. The tag management module filters out asset data received by the readers that is duplicative of earlier received asset data received in response to the scanning done by the readers. In some embodiments in which the asset management module 102 communicates directly with the readers 106, the asset management module 102 performs the function of managing the scan schedule and filtering out duplicative asset data.

In some embodiments, the asset management module includes multiple Docker containers for deployment within a VPC (Virtual Private Cloud) or localized server. In some embodiments, the Docker containers include an asset database, an ML (Machine Learning)/AI (Artificial Intelligence) chain, an API (Application Programmable Interface), a hardware agent and an external client interface. In some embodiments, the asset database stores asset data. In some embodiments, the API serves as an arbiter for the system to allow external clients access to features provided by the automated real-time asset management system.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration, these drawings are not necessarily made to scale.

FIG. 1 illustrates a block diagram of various embodiments of an automated real-time asset management system.

FIG. 2 is an illustration of an embodiment in which the asset management module is in direct communication with the readers.

FIG. 3 illustrates a block diagram of various embodiments of an architecture of the asset management module associated with the automated real-time asset management system of FIG. 1.

FIG. 4 illustrates a block diagram of various embodiments of an ML/AI chain within the architecture of the asset management module of FIG. 3.

FIG. 5 illustrates a block diagram of various embodiments of the Long-Range Asset Tag Reader of FIG. 3.

FIG. 6 illustrates a block diagram of various embodiments of a wireless power transmitter of FIG. 1.

FIG. 7 illustrates a block diagram of various embodiments of an asset tag of the automated real-time asset management system of FIG. 1.

FIG. 8 illustrates a flowchart of various embodiments of a method of operating the system of FIG. 1.

FIG. 9 illustrates a flowchart of various embodiments of a method for the operation of the system of FIG. 3.

FIG. 10 illustrates a flowchart of various embodiments of a method implemented by the system of FIG. 4.

FIG. 11 illustrates a flowchart of a method of the operation of a tag in accordance with an embodiment of the disclosed method and apparatus.

The figures are not intended to be exhaustive or to limit the claimed invention to the precise form disclosed. It should be understood that the disclosed method and apparatus can be practiced with modification and alteration and that the invention should be limited only by the claims and the equivalents thereof.

### DETAILED DESCRIPTION

Several embodiments of the disclosed method and apparatus are described and shown in the drawings. It should be understood that these embodiments are provided as examples of the claimed invention and are not intended to limit the scope of the claimed invention to the specific embodiments shown and described herein.

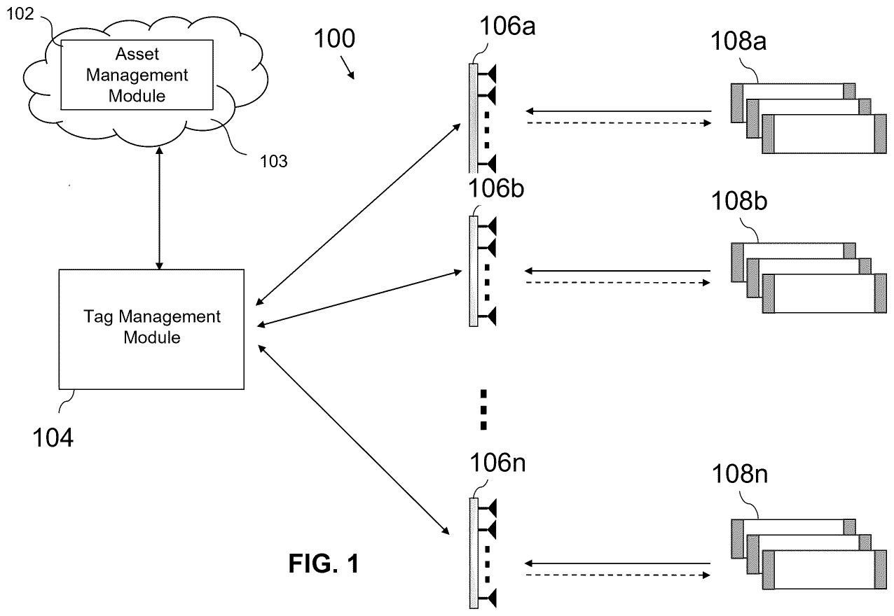

FIG. 1 is a diagram of an automated real-time asset tracking and management system 100 according to some embodiments of the present apparatus. The system 100 comprises asset management module 102, a tag management module 104, one or more long-range asset tag readers (hereafter referred to simply as “readers”) 106a-n and one or more asset tags (hereafter referred to simply as “tags”) 108a-n. It should be noted that in some embodiments (not shown), the functions of the tag management module are performed by the asset management module. In other embodiments, at least some of the functions of the tag management module are performed by the readers 106. Accordingly, some embodiments of the automated real-time asset tracking and management system do not have a tag management module 104.

It should be noted that features shown in the figures that have a reference designation that has the same numeric value followed by a different alphabetic character are referenced collective using the numeric value without an alphabetic character. For example, tag 108 refers to all the tags 108a-n. Furthermore, each element (such as the tags 108) may operate similar to other elements having the same numeric value (i.e., tag 108a, 108b, etc). Therefore, when referring to any one of the elements (such as tag 108a), the reference having only the numeric portion (i.e., 108) is used to generically refer to any one particular element (i.e., tag 108a, 108b, etc). A similar convention applies to other elements (e.g., readers 106a-n/106a) throughout the specification.

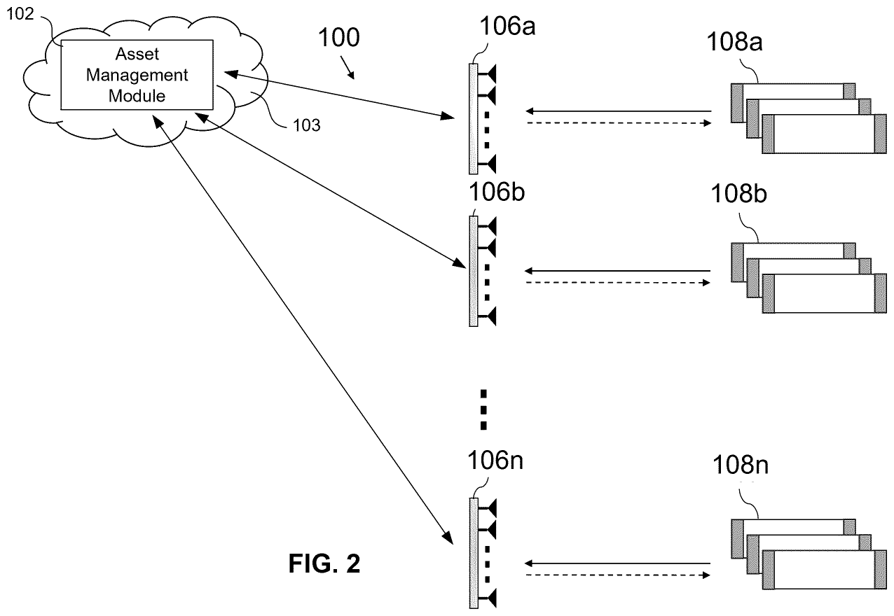

In some embodiments, the asset management module 102 resides in a cloud 103 (e.g., is accessible through the internet), making it accessible to users and allowing information regarding tags 108 to be stored. The asset management module 102 receives and stores asset data. In some embodiments, the stored data is used to automate asset procurement policies, for example by using predictive analytics derived from machine learning algorithms. In some embodiments, the asset management module 102 is coupled to readers 106 within the asset tracking system. In some embodiments, that coupling is direct. FIG. 2 is an illustration of an embodiment in which the asset management module 102 is in direct communication with the readers 106. In other embodiments, the coupling is via bi-directional communication with the tag management module 104. In some embodiments, a communication link between the asset management module 102 and the tag management module 104 is established over wired ethernet protocol or a wireless protocol, such as LTE (Long Term Evolution), NR (New Radio), etc.

In some embodiments in which communication is through the tag management module 104, the tag management module 104 is in bi-directional communication with the one or more readers 106. Such bi-directional communication links can be either wired or wireless. In some embodiments, the tag protocol/bidirectional communication link between the tag management module 104 and the reader 106 uses a protocol such as one of the following wired or wireless communication protocols: UHF RFID (Ultra High-Frequency Radio Frequency Identification), a protocol based on an IEEE 802.11 standard, an IEEE 802.15.4 standard, a protocol based on a WiFi direct, a short-range wireless protocol, Bluetooth, MiWi, ZigBee, Zwave, etc.

In some embodiments, the tag management module 104 manages a scan schedule that determines when the readers 106 will transmit signals in an attempt to identify tags 108. In addition, the tag management module 104 filters out duplicate asset data received by the readers 106 in response to signals transmitted by the readers 106. In some embodiments in which the asset management module 102 communicates directly with the readers 106, the asset management module 102 performs the function of managing the scan schedule and filtering out duplicative asset data.

In some embodiments, the tag management module 104 provides the scan schedule to the reader 106a to cause the reader 106a to transmit an unmodulated RF (Radio Frequency) power signal into a particular geographic space (i.e., “scan” for tags 108). The scan schedule is used to move the unmodulated RF power signal through several such geographic spaces in an attempt to scan for (i.e., transmit to) any tags 108 that are within range.

In some embodiments, in response to the scan schedule provided by the tag management module 104, the reader 106a dynamically controls the direction of the power signal to allow energy to be focused in one or more relatively narrow transmit paths. In addition, by controlling the power, the distance of the receiving tag to be estimated. That is, by incrementally increasing the power level of the signal until a tag 108 responds, the reader 106, tag management module 104 or asset management module 102 can estimate the distance to the tag 108. It should be understood that in alternative embodiments in which the power signal is used to provide power to a tag 108 that might have differing amounts of power stored in their power supply, the amount of power that is present in the tag 108 prior to the tag 108 receiving the power signal will determine how much power needs to be received by the tag 108. Therefore, determining the distance to a tag 108 based on the power level sent to that tag 108 will only be accurate if the power level of the tag 108 prior to receiving the signal can be determined and taken into account. However, in some embodiments, the tag has no independent source of power and relies on the reader for all of its power. Therefore, each tag will be in a similar state regarding the amount of power available prior to receiving power from the reader.

In some embodiments, in addition, to using the power level of the transmission to the tag 108, triangulation using several readers 106 that make contact with the same tag 108 can assist in determining the location of the tag 108. Other techniques may further assist in determining the location of the tag.

In some instances, the reader 106a and one or more tags 108 are in line-of-sight to one another allowing for a direct line-of-sight transmission path. In other instances, no such direct path exists and the transmit paths between the reader 106a and one or more tags 108 require the signals to reflect off objects, such as a ceiling, walls, a floor or other objects. In such instances, the signal path is referred to as a “passive transmit path”.

In some embodiments, the frequency of the signals used to transmit power to the tags 108 is approximately 5.8 GHz. In other embodiments, other frequencies may be used. In some embodiments, once a tag 108 receives power from at least one of the readers 106, the tag 108 uses that power as a power source to receive and retransmit a data signal received from the reader 106 in response to the received power signal. By the reader 106 transmitting the power signal and the data signal as independent signals, greater system flexibility is attained, such as by allowing the power signal to be a focused beam while transmitting the data in accordance with a conventional data protocol, such as a commonly used RFID protocol. Accordingly, power can be provided more efficiently and at a greater distance while still using a less complex data protocol. In addition, in some embodiments, the power signal is transmitted at a higher frequency than the data signal, allowing the power signal to be transmitted over a longer range. In some embodiments, the reader 106 transmits a data signal concurrent with the transmission of the power signal. In some such cases, the data signal is not transmitted as a directional beam, as is the power signal. Rather, the data signal is transmitted to a wide area without control of the direction of the transmissions. Alternatively, the data signal may be transmitted through a phased array antenna (either the same phased array or a second phased array) to direct the data signal in essentially the same manner as the power signal.

The retransmission of the data signal indicates the tag's presence to the reader 106 and includes a code which is modulated into a field within the signal that the tag 108 retransmits. In some embodiments, the data signal operates in accordance with a standard RFID protocol, allowing the data to be encoded into the received signal and retransmitted. The data that is modulated onto the retransmitted signal provides a means to determine asset data for the tag 108. In some embodiments, the data can be used as an index into a look up table that is used to cross reference the transmitted code to information about the asset with which the tag 108 is associated. In some such embodiments, such information includes the type of asset, the date of manufacture, the weight, size, model number, serial number, etc.

Alternatively, the data may be a direct indication of particular characteristics of the asset with which the tag 108 is associated. That is, one or more codes may be modulated onto the signal received by the tag 108, each such code indicating a characteristic of the asset with which the tag 108 is associated, such as the model number, serial number, weight, size, or other characteristics of interest to the parties that might wish to track the asset. Accordingly, the tags 108 store data about the assets associated with the respective tags 108.

In each of these embodiments, tags 108 provide a data signal that is received by the reader 106 in response to the reader 106 transmitting the power signal to a tag 108. The received data signal is coupled to the asset management module 102. The asset management module 102 thereby, in response to transmitting the power signal, receives information regarding the presence and nature of an asset associated with the tag 108 with which the asset management module 102 performs predictive analysis regarding one or more of the use, location, transportation, consumption, inventory, etc. of the assets. In some embodiments, the reader 106 can only receive the data signal if the power signal is transmitted to a tag 108 that is capable of receiving the power signal and sending the data signal in response to having received the power signal. In some embodiments, the tag 106 further must receive a data signal from the reader 106, the data signal being sent to the tag 108 by the reader 106 independent of the power signal. Accordingly, in such embodiments, the reader 106 receives the data signal in response to both the transmission of the power signal to a tag 108 capable of receiving the power signal and capable of using the power of the power signal, and in response to the reader 106 transmitting the data signal and the tag 108 receiving and retransmitting the data signal transmitted by the reader 106.

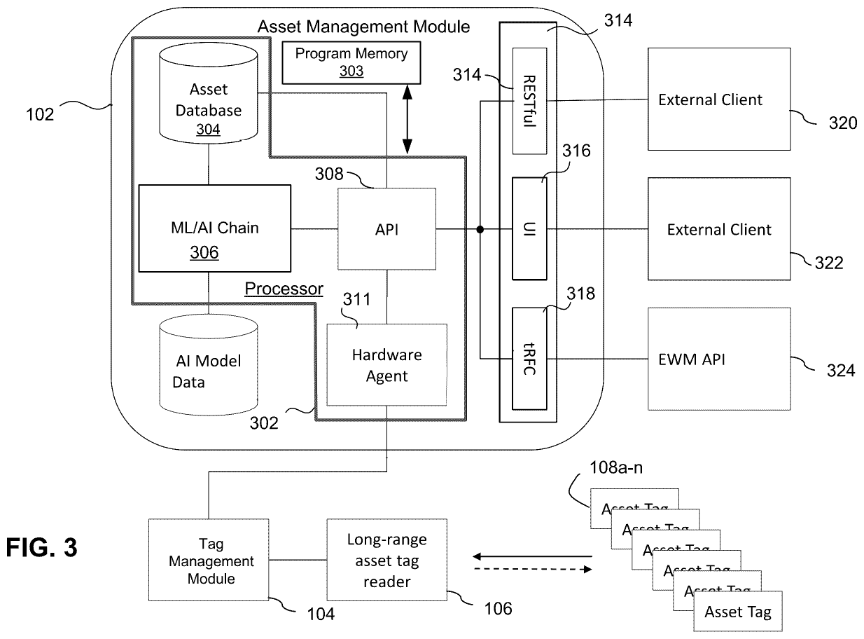

FIG. 3 is a block diagram of the system 100 showing in greater detail the asset management module 102 previously discussed with regard to FIG. 1. In some embodiments, the asset management module 102 comprises one or more processors 302, such as a programmable computers or integrated circuit chips capable of executing computer readable instructions stored within a program memory device 303. In some embodiments, multiple Docker “containers” for deployment within the same VPC (Virtual Private Cloud) or localized server are used to implement functions performed by the asset management module 102. A “container” is a standard unit of software that packages up code and all its dependencies so the application runs quickly and reliably from one computing environment to another. A Docker container image is a lightweight, standalone, executable package of software that includes everything needed to run an application: code, runtime, system tools, system libraries and settings.

Container images become containers at runtime. In the case of Docker containers, images become containers when they run on the Docker Engine. Available for Linux, Windows-based applications, and other such platforms, containerized software runs the same regardless of the infrastructure. Containers isolate software from its environment and ensure that the software in the container works uniformly despite differences for instance between development and staging. While the disclosed embodiment is described as using Docker container, other container solutions are equally applicable.

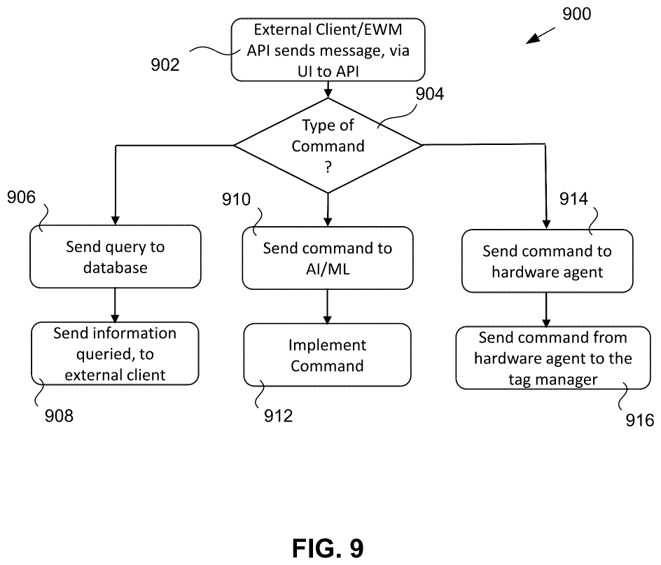

In some embodiments, the Docker containers include an asset database 304, an ML (Machine Learning)/AI (Artificial Intelligence) chain 306, an API (Application Programmable Interface) 308, a hardware agent 311 and an external client interface 312, comprising a RESTful API 314, a UI 316 and a tRFC 318, each of which is discussed below with respect to FIG. 9. For the purpose of illustration, each of these containers is shown “within” the processor 302. However, in some embodiments, the computer readable executable code of the containers resides in the program memory 303.

The asset database 304 is coupled to the ML/AI chain 306 and the API 308. In some embodiments, the API 308 serves as an arbiter for the system to allow external clients 320, 322 access to the features provided by the automated real-time asset management system 100.

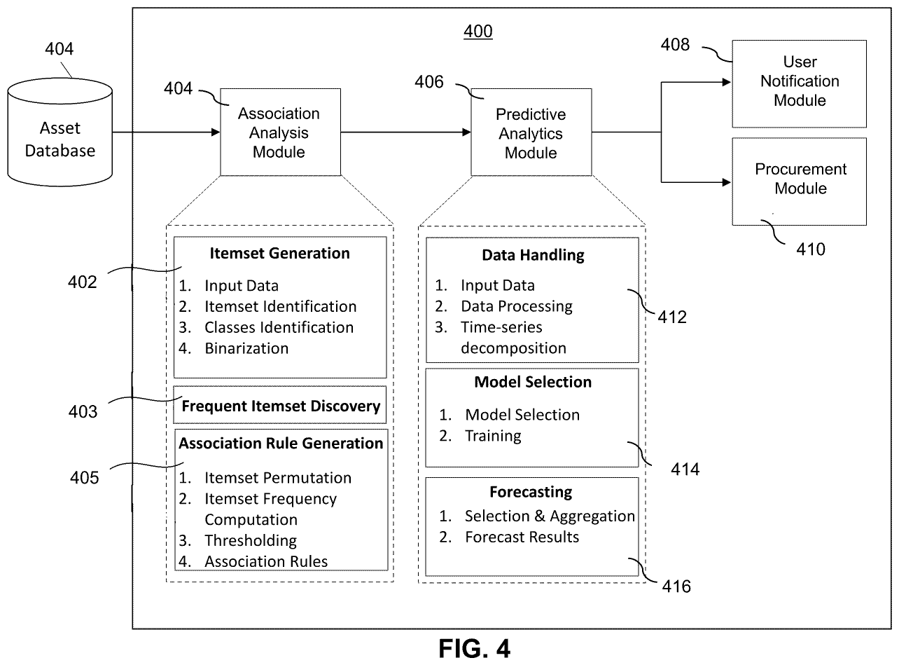

FIG. 4 is a block diagram of an ML/AI chain 400 in accordance with some embodiments of the disclosed system. In some embodiments, the ML/AI chain 306 comprises an association analysis module 404 coupled to a predictive analytics module 406. In some embodiments, the ML/AI chain 400 includes the asset database 304, an association analysis module 404 coupled to the asset database 304, and a predictive analytics module 406 coupled to the association analysis module 404.

In some embodiments, the asset database 304 stores asset data such as: (1) UPCs (Universal Product Codes); (2) the number of assets with the same UPC; (3) model numbers of assets; (4) physical locations of the assets; (5) how many of the same type of assets are being tracked; and other such tracking data. In some embodiments, identifying schemes other than UPCs are used.

In some embodiments, the association analysis module 404 analyzes associations between the data stored in the asset database 304 to discover hidden patterns and associations, particularly in the context of assets associated with the same events. For example, in a warehouse environment, the association analysis module 404 identifies assets that are being consumed at the same time (i.e., their consumption is an event that is common to those assets) or more specifically to identify assets leaving the warehouse at the same time. By identifying relationships between assets consumed (e.g., that leave the warehouse) at the same time, warehouse teams can make informed decisions that can improve packing operations, logistics generally, the layout of the warehouse, etc., in order to improve the overall efficiency of the warehouse operation. Additionally, by identifying relationships between assets that are being tracked by the system, the effort required to forecast demand and to drive the process of resupplying assets is significantly reduced. In some embodiments, the association analysis module 404 uses one of the following ML models: association rules, sequential pattern mining, clustering, decision trees, etc. It will be understood by those skilled in the art that a “model” is a rubric for associating data of a dataset so as to identify patterns, associations and relationships and thus find useful ways to handle the data and gain insight from the data. Some of the particular models that are useful are discussed below.

In some embodiments, the use of association rules facilitates a market basket analysis to identify frequent itemsets. For the purpose of this disclosure, itemsets are defined as sets of data regarding assets, wherein the data tends to appear together in transactions. Association rules are useful for uncovering co-occurrence patterns, i.e., patterns that are common to two pieces of data.

While the module 404 is referred to herein as the “association” analysis module, the selection of the model to be used depends on the goals of the specific operation and the characteristics of the available data. If the primary focus is uncovering co-occurrence patterns, such as when assets leave the facilities together, the association rules model is a good fit. However, if the goal is to identify asset sequences, complex relationships, or predictive modeling, other models, such as decision trees and sequential pattern mining may be more useful.

In some embodiments, the association analysis module 404 discovers different patterns between different assets associated with similar events. In some embodiments, the predictive analytics module 406 predicts future event behavior for the assets while utilizing the asset groups identified by the association analysis module 404 to improve processing efficiency. For example, developing a single forecasting model for a group of assets as opposed to developing a different forecasting model for each of the assets, significantly reduces model development or training time and the computational resources required. When tracking relatively large inventories, it becomes difficult to use predictive analytics in the predictive analytics module 406 to make predictions without having developing association rules, such as those developed in the association analysis module 404.

In some embodiments, the association analysis module 404 performs a method that comprises three main elements, performed in the following order: (1) itemset generation 402, (2) frequent itemset discovery 403 and (3) association rule generation 405.

Looking first at itemset generation, itemset generation comprises the following four elements: (1) data input, (2) itemset identification, (3) class identification and (4) binarization.

Itemset identification includes finding and extracting sets of items that frequently co-occur in a given dataset and discovering associations between such co-occurring items. Class identification includes discovering relationships and associations between the identified itemsets. Initially, data is input into the association analysis module 404. Alternatively, the data may be placed in memory that is accessible to the association analysis module 404. Once itemsets and classes of data have been identified, parameters, relationships, conditions or states of items are binarized.

Binarization is the process of converting relationships and other variables into one of two values (e.g., true/false)—indicating whether a relationship or other conditions exist. For example, if a variable has a value above a certain threshold a relationship exists, whereas if the value is below a threshold, the relationship does not exist. The binarization converts non-binary data into a binary form suitable for discovering binary relationships between items.

In some embodiments, frequent itemsets are discovered, including discovering binary relationships between items. In some embodiments, frequent itemset discovery facilitates discovering the presence of itemsets and whether an item belongs to an itemset by determining which items satisfy a binary relationship associated with that itemset. The association rule generation comprises itemset permutation, itemset frequency computation, thresholding and association rules. In some embodiments, the itemset permutation involves rearranging the order of items within an itemset to explore different permutations of items for discover similar patterns. The itemset frequency computation involves counting the occurrences of items belonging to an itemset (e.g., which facilitates figuring out whether to procure more of the items in the itemset).

Frequency itemset discovery includes assessing if items meet a specific threshold. Itemset frequency computation includes assessing an exact number. For example, itemset frequency discovery includes determining how many items of an itemset are left in the warehouse at a particular time.

Thresholding sets a minimum support or confidence threshold to filter out associations that are considered to be weak. Accordingly, the application of such thresholds can be used to create rules that result in associations between items, itemsets or classes that can be considered to be relatively strong.

In some embodiments, the predictive analytics module 406 implements the following steps in the data handling procedures 412 in the following order: data input, data pre-processing, and time series decomposition. Next, model selection 414 including training are performed. Lastly, forecasting 416 is performed, including: results selection; results aggregation; and forecasting the results. In some embodiments, data is provided to the predictive analytics module 406. Alternatively, data is stored in memory to which the predictive analytics module 406 has access. In some embodiments, data pre-processing involves cleaning and transforming raw data into a format suitable for analysis. In some embodiments, transforming of the raw data includes handling missing values, smoothing noisy data, and transforming variables for better model performance. In some embodiments, the time series decomposition is a process of breaking down a time series into its underlying components, which include identifying trends, seasonality and residuals (the unexplained or random variation in the time series data after removing the systematic components, such as the trend and seasonality). For example, the time of arrival of an inventory item is grouped with the time at which the inventory is sold or shipped.

In some embodiments, the time series decomposition allows for a better understanding of patterns and facilitates modeling. In some embodiments, the model selection includes choosing an appropriate forecasting model for a given dataset. Once the model is selected, the selected model is trained. Forecasts are generated based on the trained model. The data is selected and aggregated and results are forecasted based on the aggregated data and model selected.

The model selection requires evaluating various models, considering the assumptions of the model selected, and selecting the model that best captures the underlying patterns in the data. In some embodiments, the training of a forecasting model involves using historical data to estimate model parameters. The model selection includes processing the model to learn patterns and relationships within the data, enabling the model to make accurate predictions about new, unseen data. Finally, the forecasting results include generating predictions by forecasting events expected to occur at a future time. The results of the forecast provide insights into expected demand patterns and are useful for making informed decisions related to inventory, production planning, and resource allocation. The association analysis module 404 works better with the predictive analytics module 406.

In the context of demand forecasting, inventory management and association rules, various ML (Machine Learning) models facilitate uncovering patterns, relationships and insights from transactional data. Some of the ML models are suited for use with the association analysis module 404, while other ML modules are suited for use with the predictive analytics module 406. In some embodiments, the association analysis module 404 uses one or more of the following models: (1) association rules, (2) sequential pattern mining, (3) clustering and (4) decision trees. The association rules, sequential pattern mining, clustering and decision trees serve different purposes and can interact with each other in a complementary way.

In some embodiments, association rules facilitate a starting point for identifying item relationships. The association rules provide valuable insights into which items are often bought together. For example, discovering that “bread” and “butter” are frequently purchased together.

The sequential pattern mining identifies sequences of items that frequently occur together in a specific order. The sequential pattern mining further considers the order of item appearances in transactions.

The sequential pattern mining extends the insights from association rules by revealing the temporal aspect of item associations. For instance, The sequential pattern mining may indicate that customers tend to buy “coffee,” followed by “sugar,” and then “milk” during their morning routine. Thus, in this example, when an order for coffee is detected, after or while fulfilling the order for coffee, first sugar and then milk are prepared (e.g., moved to a more easily accessible location) to be ready when (and if) ordered.

Clustering, groups similar items or transactions together based on their features or characteristics. Clustering facilitates segmenting the data into meaningful clusters or classes, for example, to create customer segments based on purchasing behaviors. As a more particular example, clustering can be used to group customers as “Health-Conscious Shoppers” or “Budget Shoppers” based on their buying patterns. These clusters can then be used as an input to other models.

Decision trees facilitate classification and provide a mechanism by which to identify associations. In the context of inventory management, decision trees can facilitate predictive modeling, especially facilitating forecasting demand or predicting future sales by providing associations that can then be used to make predictive models more efficient. Decision trees can can provide insights into associations to make predictions more efficient.

In some embodiments, the predictive analytics module 406 performs predictive analytics using one or more of the following models: ARIMA (Auto-Regression Integrated Moving Average), exponential smoothing and Prophet. The prophet model is the most advanced in terms of handling complex data. The Prophet model is a generalized additive model. That is, the Prophet model consists of nonlinear terms that are added together. In some embodiments, the Prophet model has three different nonlinear terms: a trend, seasonalities, and holidays. In other embodiments, the number of nonlinear terms may differ. Additionally, in some embodiments, there is a distributed error term. All of the terms depend on time.

Preprocessing the data before applying an ML module can facilitate building the ML model. In some embodiments, such data preprocessing includes encoding the data as categorical variables, handling missing values, and scaling data. Encoding data into categorical variables entails dividing the data by into groups and encoding the data based on the group to which the data belongs. Examples of categorical variables for product and inventory related applications include: size; weight; type of packaging, whether fragile, use related metrics (such as where a product is used, by whom the product is used, etc.); type of product. Examples of categorical variables when dealing with people include: race; sex; age range; level of educational; demographic data of a population; blood type; marital status, etc.

The models discussed herein typically benefit from clean and well-prepared data. Features extracted from the association rules, the sequential patterns or the clustering can be used as inputs for decision tree models. For example, the presence of certain frequent itemsets or clusters can be a feature in a decision tree model.

Ensemble techniques, models and decision trees, when combined with the insights from other models can be used to create ensemble models that improve the accuracy of the underlying model. For example, combining decision trees with clustering can help tailor forecasts to specific customer segments.

In some embodiments, the models operate within a feedback loop. For example, the results of decision tree forecasts can be fed back into the system to adjust inventory levels. The results of the feedback can be incorporated into the next round of association rule mining or clustering to adjust the models further.

The models, including the ML models, association rules, sequential pattern mining, clustering, and decision trees, work together to provide a comprehensive approach to demand forecasting and inventory management. Each model plays a specific role in uncovering patterns and relationships, and the interactions allow for a more nuanced understanding of customer behavior and optimized inventory strategies.

At the end of the ML/AI chain 400, a user notification module 408 sends notifications to users about changes made by the ML/AI chain 400. In some embodiments, the user notification module 408 is a processor that is configured to receive information from the predictive analytics module 406 to be output in the form of a notification to a user. Also, a procurement module 410 generates policies to automatically procure inventory based on data provided by the other elements of the ML/AI chain 400.

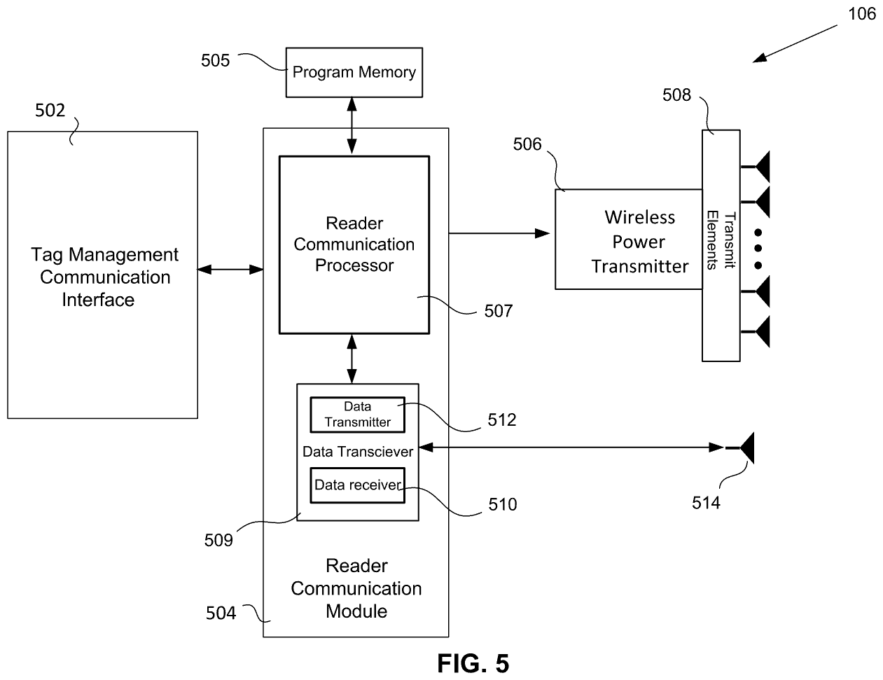

FIG. 5 shows a block diagram of the reader 106a according to some embodiments of the present apparatus. In some embodiments, the reader 106a comprises a tag manager communication interface 502, a reader communication module 504, a wireless power transmitter 506 and a plurality of transmit elements 508, such as transmit apertures.

In some embodiments, bi-directional communication between the tag management module 104 and the reader 106a is established through the tag management communication interface 502. In some embodiments, the tag management communications interface 502 is configured to communicate with the tag management module 104 in accordance with a wired ethernet protocol or with a wireless protocol, such as Wi-Fi. In other embodiments, other protocols for establishing communications may be used.

In some embodiments, internal communications between the tag management communication interface 502 and the reader communication module 504 uses one of the following digital communication interfaces: Serial Peripheral Interface (SPI), I2C (Inter-Integrated Circuit), USB (Universal Serial Bus), UART (Universal Asynchronous Receiver/Transmitter) or other digital communication interfaces.

The reader communication module 504 comprises a reader communication processor 507 that in some embodiments is a device capable of reading and executing machine readable code. In some embodiments, the executable code is stored in a memory device 505. While the memory device 505 is shown to be external to the reader communication module 504, in other embodiments, the memory device 505 may be integral to the processor 507 within the reader communication module 504.

In some embodiments, a data transceiver 509 comprises a data receiver 510 and a data transmitter 512. In some embodiments, the data transceiver 509 is a WPAN module that implements a WPAN software stack and a WPAN transceiver physical layer. In other embodiments, the data transceiver 509 is an RFID interface module. In some embodiments, the data transceiver 509 is implemented by the reader communication processor 507. In some embodiments, the data transceiver 509 is implemented by a combination of the reader communication processor 507 and data transceiver hardware 509, such as an RF microcontroller IC (Integrated Circuit) that implements the WPAN transceiver physical layer based on the selected wireless protocol or an RFID protocol. The data transceiver 509 supports communicating data signals between the reader 106 and tags 108 through an antenna element 514. In some embodiments, data signals received from the tags 108 use TDM (Time Division Multiplexing) and/or FDM (Frequency Division Multiplexing) to minimize collisions between tags 108 that are transmitting at the same time. In some embodiments, the tag collisions are further reduced by adding a random delay between the time the tag 108 is powered up by receipt of a power signal, to the time the tag transmits asset data. A tag collision occurs when the signal from two different tags cannot be distinguished or when a device that is not part of the system responds to the scan. The impact of a collision is further mitigated by the reader 106a continuously and automatically scanning the tags 108.

In some embodiments, the power signal is transmitted by a wireless transmitter 506 that is coupled to the transmit elements 508. Such power signals are generated by the wireless transmitter 506 and transmitted through the transmit elements 508. The power signal is an unmodulated signal, such as a pure sine wave that is transmitted to tags 108 to provide power to the tags 108 (i.e., as a power source for the tags 108).

The plurality of the signals transmitted through the transmit elements 508 for the composite power signal.

Internal signals between the application processor 610 and the channel processor 630 use a digital communication interfaces, such SPI (Serial Peripheral Interface), I2C (Inter-Integrated Circuit), USB (Universal Serial Bus), UART (Universal Asynchronous Receiver/Transmitter). In other embodiments, other digital communication interfaces may be used.

The power signal provides enough power to tags 108 to allow them to operate in cases in which the receiving tag 108 has little or no power stored. In some embodiments, the tags 108 are incapable of storing power for more than a few minutes. Therefore, power must be provided by the read 106 for a tag 108 to operate.

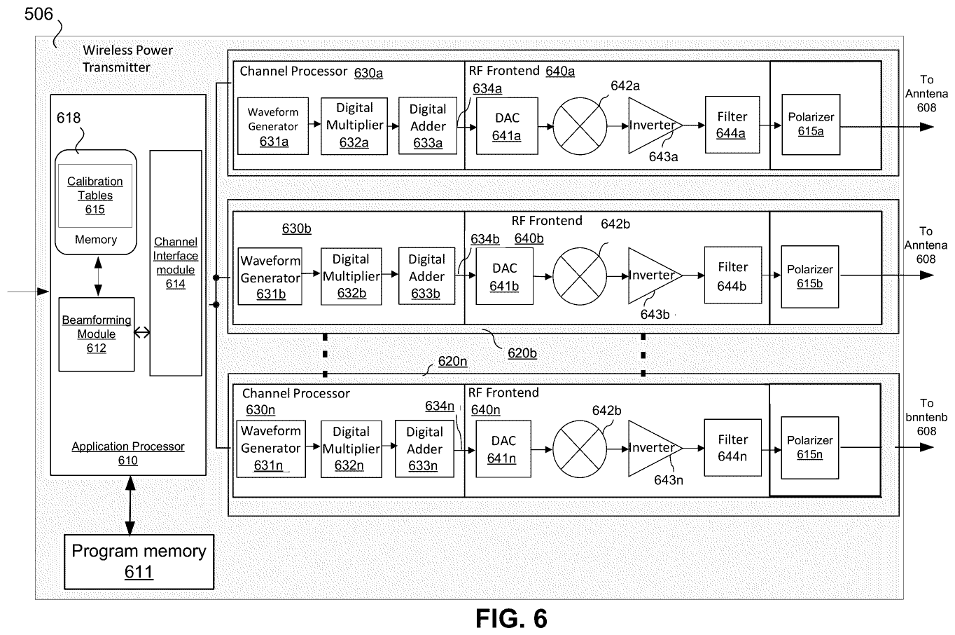

FIG. 6 is a more detailed block diagram of the wireless power transmitter 506 shown in FIG. 5. The wireless power transmitter 506 comprises an application processor 610, a memory device 611 and a plurality of wireless power transmitter channels 620a-n. In some embodiments, the application processor 610 is a device capable of reading and executing machine readable code, such as a computer or integrated circuit processor. In some embodiments, the executable code is stored in the memory device 611 within the application processor 610.

In some embodiments, the code executed by the application processor 610 implements modules, including a beamforming module 612, a communication interface driver module 614 and code to access and store calibration tables 615 in memory 618. In some embodiments, the memory 618 is independent of the memory device 611 which is used to store executable code. However, while the memory 618 is shown as distinct from the memory device 611, the two may be implemented in the same memory device. In some embodiments, one or both memory devices 611, 618 are an integral part of the application processor 610. In other embodiments, the one or both memory devices 611, 618 are discrete memory devices separate from the application processor 610, in which the calibration tables 615 and executable code are stored and which is accessible to the application processor 610.

In some embodiments, the beamforming module 612 forms a beam and sets the direction of the beam formed from a composite power signal transmitted by the wireless power transmitter 506 to focus energy of the composite power signal in a desired direction by setting and controlling characteristics of the plurality of power signals transmitted by the wireless power transmitter channels 620. This results in the composite power signal being transmitted in the desired direction. Each of the signals are coupled to one of the transmit elements 508. In some embodiments, the plurality of power signals are unmodulated power signals. In some embodiments controlling and setting the characteristics is done by dynamic adjustments to the digital signal amplitude and phase for each of a plurality of signals transmitted through the transmit elements 508. Setting these parameters allow for dynamic control of the beam direction, the RF power level and the beam width. In some embodiments, setting the characteristics includes computing digitally calculated phase relationships and amplitude relationships between beam elements determined in the RF domain. In other embodiments, phase and amplitude relationships between beam elements are determined within a LO (Local Oscillator) that modulates the transmitted beam elements. In yet other embodiments, phase and amplitude adjustments are made at an IF (Intermediate Frequency), etc. In some embodiments, phase adjustments for each of the wireless power transmitter channels 620 and a calculating digital waveform based on spherical coordinate theta and phi input (the azimuthal angle and the polar angle, respectively) are performed by the beamforming module 612 and the calibration tables 615. In some embodiments, computation of the phase adjustments is based on exciting an electromagnetic plane-wave with a uniform phase front in the desired transmit direction where theta represents the tilt of the beam from the boresight of the antenna and phi represents the beam rotation. For example, in some embodiments, implementing the beamforming module 612 is performed with a look-up table for each transmit-beam direction stored in the memory of the application processor 610. The output from the beamforming module 612 is the phase adjustments for each of the wireless power transmitter channels 620, which is sent to a corresponding one of channel processors 630, via the communication interface driver 614. In other embodiments, the beamforming module 612 is implemented in each channel processor 630 instead of by the application processor 610. This embodiment allows phase adjustment calculations for each of the wireless power transmitter channels 620 to occur in parallel, reducing the processing time and latency when changing transmit directions.

The calibration tables 615 comprise calibration phase coefficients and amplitude coefficients correlated with temperature for each of the wireless power transmitter channels 620. The calibration tables 615 are stored in the memory of the application processor 610 and are combined with the channel amplitude and phase adjustments before being sent to the channel processors 630. In some embodiments, the beamforming module 612 automatically changes the beam direction in accordance with a pre-determined pattern to power the tags 108 in different locations and collect data from the assets.

In some embodiments, the wireless power transmitter channels 620 are coupled to the application processor 610 by a digital communication interface 625, which is configured as an SPI (Serial Peripheral Interface), I2C (Inter-Integrated Circuit), USB (Universal Serial Bus), or other digital communication interfaces. Each of the wireless power transmitter channels 620 comprises a channel processor (such as the channel processor 630a), an RF frontend (such as the RF frontend 660a) and an antenna (such as the antenna 650a). In some embodiments, a single wireless power transmitter channel, such as the wireless power transmitter channel 620a, is implemented in an RF ASIC (Application Specific Integrated Circuit). In such embodiments, the ASIC implementation of the wireless power transmitter channel would not include the antenna (such as, for example, the antenna 650a). In other embodiments, one or more of the channel processors 630 comprises a single FPGA (Field Programmable Gate Array) operably coupled to a respective DAC (Digital-to-Analog Converters), such as the DAC 641a. In some embodiments, the channel processors 630 each comprise a digital waveform generator 631, a digital multiplier 632 and a digital adder 633.

In some embodiments, the beamforming module 612 automatically changes the direction of the transmit beam (i.e., scans) in accordance with a set time interval based on the scan schedule sent to the beamforming module 612 by the tag management module 104 through the tag management communication interface 502. In some such embodiments, the transmit beam transmitted through the transmit elements 508 can track a tag 108 under the control of signals from the tag management module 104 once the tag 108 has been found. Such tracking allows the reader 106 to provide power to the tag 108 over time and to track a tag 108 that is in motion. Asset data received from the tags 108 is stored in the asset database 304 (see FIG. 2) in association with the transmit-direction of the power signal beam used to provide power to the transmitting tag 108.

In some embodiments, a digital waveform generator 631 generates one digital waveform per transmitted signal, with each transmitted signal having a phase that is determined with respect to a clock generated by the associated channel processor 630. The relative phases of each of the signals of a set of transmitted signals determines the direction of a transmit-beam that is formed by the combination of the set of transmitted signals. In some embodiments, the digital waveform generator 631 uses a LUT (Lookup Table) to generate the transmitted signals. The amplitude of the transmitted signal is represented by a series of M samples, where M is determined based on the desired phase resolution. The amplitude of each of the M samples in the waveform has a value represented by N bits, where the value N determines the amplitude resolution. In some embodiments, the waveform generator 631 receives data from the beamforming module 612, which the waveform generator 631a uses to select the corresponding amplitude value from the LUT. Controlling the values selected by the waveform generator 631 allows waveforms of different the various transmitted signals to generate a beam in the desired transmit direction. In other embodiments, the waveform generator 631 is implemented by generating an oversampled 1-bit digital waveform with M samples per period of the selected baseband frequency. In some embodiments, the phase adjustments are performed by delaying the waveform by the required number of samples in the digital domain.

In some embodiments, the digital multiplier 632 receives a complex number input from the application processor 610 representing amplitude and phase adjustment for the respective wireless power transmitter channel 620, perform multiplication between the received complex number and the generated digital waveform, and take the real part of the result. In some embodiments, the amplitude adjustment is used for amplitude calibration of each wireless power transmitter channel 620 and to set the power level for the respective transmit beam. In some embodiments, the phase adjustment is used as an alternative way to adjust the waveform phase. In some embodiments, the digital adder 633 superimposes two or more waveforms for a single wireless power transmitter channel 620 when more than one transmit-beam is generated.

In some embodiments, a plurality of RF frontends 640a-n are associated with and coupled to corresponding channel processors 630a-n with associated and corresponding serial or parallel interfaces 634a-n. In some embodiments, each RF frontend 640 comprises: a DAC (Digital-to-Analog Converter) 641, a frequency upconverter 642 coupled to the DAC 641, an RF inverter 643 coupled to the frequency upconverter 642, and a band select filter 644 coupled to the RF inverter 643.

The DAC 641 converts a digital waveform to an analog waveform. The required number of bits for the DAC 641 is based on the dynamic range of the wireless power transmitter 506 and the minimum required phase adjustment for the waveform. For example, in some embodiments, the DAC 641 is configured as an 8-bit DAC leading to 48 dB of dynamic range and approximately 0.7 degrees of phase resolution if phase adjustments are performed using the digital waveform generator 631. In other embodiments, the DAC 641 is configured as a low pass filter or bandpass filter, and the DAC converts a digital signal to an analog signal by filtering higher-order harmonics. For example, if the output signal from the channel processor 630 is a 1 MHz digital signal then the DAC 641 is configured as a bandpass filter centered at 1 MHz with enough rejection at 2 MHZ and above, for example, 20 dB or more, to filter higher-order harmonics and generate a sinusoidal waveform at 1 MHz at the output.

The frequency upconverter 642 converts a baseband or Intermediate Frequency (IF) signal to an RF signal and filter spurious frequency tones. In some embodiments, the frequency upconverter 642 comprises a direct conversion mixer or IQ (In-phase/Quadrature-phase) mixer, which has good single, sideband rejection performance. In other embodiments, the frequency upconverter 642 is configured as a PLL (Phased Lock Loop).

The RF inverter 643 converts an input DC signal to an RF signal and set the power level for the transmitted signal. In some embodiments, the RF inverter 643 comprises a linear amplifier or a switch mode inverter, which leads to higher efficiency for operation with a single beam. The band select filter 644 is configured as a bandpass filter to reject unwanted frequency tones and ensure compliance with RF emission specifications for the selected band.

The antenna 650 is operably coupled to its associated and respective RF frontend 640. In some embodiments, the antenna 650 comprises a polarizer 651 a, which may set the polarization for the radiated electromagnetic field and perform impedance matching, and an aperture 652a operably coupled to the polarizer 651a. In some embodiments, the polarizer 651a is configured as a feed network with two microstrip lines feeding the square microstrip aperture on two adjacent sides with one of the microstrip lines physically longer to provide additional 90 degrees of phase shift and excite a circularly polarized wave. The aperture 652a is coupled to the polarizer 651a, wherein the aperture 652a transmits the RF power signal. In some embodiments, the aperture 652a is a square microstrip aperture with circular polarization which provides good performance and allows for easy integration with the rest of the wireless power transmitter 506 on a single PCB (Printed Circuit Board). In other embodiments, the aperture 652a comprises other microstrip aperture configurations to achieve similar functionality such as a circular patch, a stacked patch or other apertures. The aperture to aperture maximum spacing (which in some embodiments is the spacing between the aperture 652a and the aperture 652b), is, in some embodiments, configured for half a wavelength to one wavelength, as determined by the maximum scan angle at the operating frequency. Setting the aperture to aperture separation above the maximum separation introduces large grating lobes in the transmitted antenna pattern. In some embodiments, the antennas and the RF frontends operate in ISM (Industrial, Scientific and Medical) unlicensed bands including frequency ranges of 2.4 GHz to 2.5 GHZ, 5.725 GHz to 5.875 GHz, 24 GHz to 24.25 GHz, or 61 GHz to 61.5 GHZ.

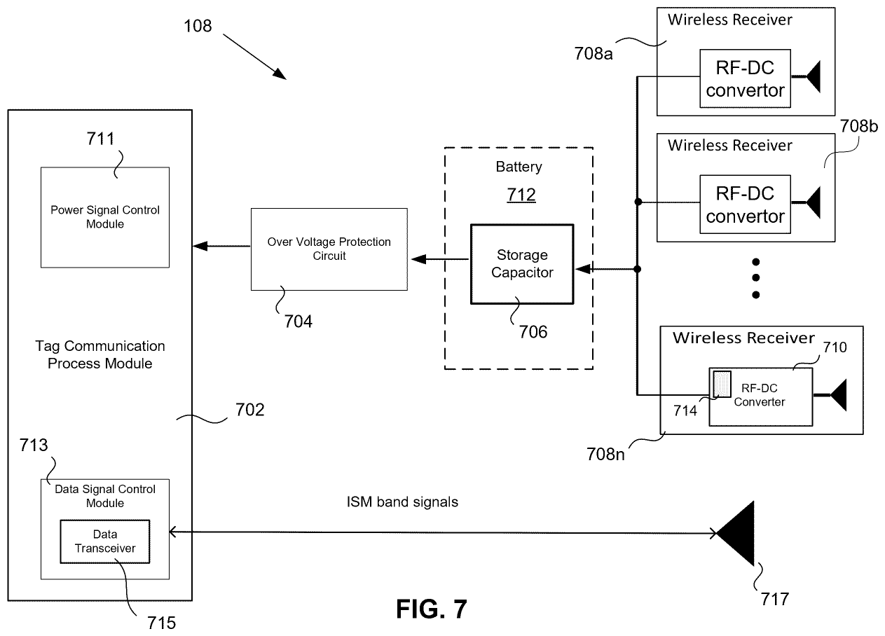

FIG. 7 illustrates a block diagram of a tag 108, such as the tags 108a-n according to various embodiments of the present apparatus. In some embodiments, the tag 108 comprises one or more wireless power receivers 708a-n. In addition, the tag 108 comprises one or more storage capacitors 706 coupled to one or more wireless power receivers 708. An OVP (Over-Voltage Protection) circuit 704 is coupled to the storage capacitors 706 and to a tag communication processor 702. In some alternative embodiments, a battery 712 (shown in dotted line to indicate that the battery 712 is optional) is included in addition to, or instead of, the storage capacitor 706.

In some embodiments, each of the wireless power receivers 708 comprises an RDC (RF-to-DC power converter) 710 coupled to an antenna, such as an aperture in some embodiments. In some embodiments, the aperture receives the RF power signal. In some embodiments, the aperture is a printed aperture with different types of polarizations including linear polarization and circular polarization, allowing for easy integration with the rest of the tag electronics on a single piece of dielectric material, such as an inlay or PCB (Printed Circuit Board). In some embodiments, the wireless power receiver 708 operates in frequency ranges of 2.4 GHz to 2.5 GHZ, 5.725 GHz to 5.875 GHz, 24 GHz to 24.25 GHz or 61 GHz to 61.5 GHZ, which are ISM (Industrial, Scientific and Medical) unlicensed bands.

The RDC 710 converts the RF power signal to a DC power output. In some embodiments, a single-stage voltage multiplier 714 is used as a full wave rectifier capable of achieving high conversion efficiency. Only one such voltage multiplier 714 is shown for the sake of efficiency, however, some or all of the RDCs 710 may have a voltage multiplier 714. In some embodiments, High-Frequency RF-to-DC conversion facilitates impedance matching to improve efficiency by reducing the reflected signal due to off-state diode capacitance. It should be noted that while several wireless power receivers 708 are shown, in some embodiments, only one such wireless power receiver 708 is present. Furthermore, in contrast to the plurality of power transmitting ports in the transmit elements 508 of the reader 106, the plurality of wireless receivers 708 within the tag 108 are for the purpose of collecting energy more efficiently to convert the power transmitted by the reader 106 to DC power that is output for use by the tag 108. It should also be noted that since the power signal is not modulated, there is no need for a demodulation, downconversion of the RF signal or filtering that is commonly associated with an RF receiver, making the use of several such wireless power receivers 708 inexpensive and possible with a relatively small footprint.

The wireless power receivers 708 are coupled to the tag communication process module 702 to receive the DC power output by the wireless power receivers 708. In some embodiments, this coupling is through the storage capacitors 706, which temporarily store energy for powering the tag communication processor 702. The storage capacitor values are selected so that when the storage capacitor voltage reaches the required voltage to power the tag communication processor 702, there is a sufficient amount of energy stored in the storage capacitor 706 to allow the tag communication processor 702 to send one or more transmit-packets containing the desired asset data, such as the UPC or other type of asset identification data. The storage capacitors 706 allow for a direct tradeoff between the tag detection distance and the amount of time the reader 106a spends sending RF transmit power to a specific tag (108a). As used herein, tag detection distance is defined as the physical distance between the reader 106a and the tag 108a. The longer the detection distance, the more time the reader 106 needs to power the tag 108a sufficiently to allow the tags 108a to send transmit packets. The trade-off between the distance and the time required to power the tag 108a is a direct consequence of the RF power density having an inverse square relationship with the detection distance. However, by increasing the number of wireless power receivers 708, for the same detection distance, the energy captured in a predetermined time is increased (or alternatively, the amount of time required to capture sufficient energy is reduced).

In some embodiments, the coupling of the wireless power receivers 708 and the tag communication process module 702 is further though the OVP 704, which limits a voltage of the storage capacitors to prevent the voltage from exceeding a maximum safe voltage level. In some embodiments, the OVP circuit 704 is implemented as a reverse-biased diode such as a Zener diode. In some embodiments, a power signal control module 711 within the tag communication processor 702 determines when power has been received. In some embodiments, the power signal control module 711 is performed by the tag communication processor 702.

In some embodiments, a data signal control module 713 is configured as an RF communication microcontroller to transmit asset data. In some such embodiments, the data signal control module 713 is implemented by the tag communication processor 702 executing computer readable code stored in local memory and controls a data transceiver 715 to receive and transmit data between the tag 108 and the reader 106 through an antenna 717.

In some embodiments, the communications signals and the power signals can be distinguished from one another as a result of each having a different frequency. In some embodiments, the communications signals and the power signals can be distinguished from one another as a result of each being sent at different times.

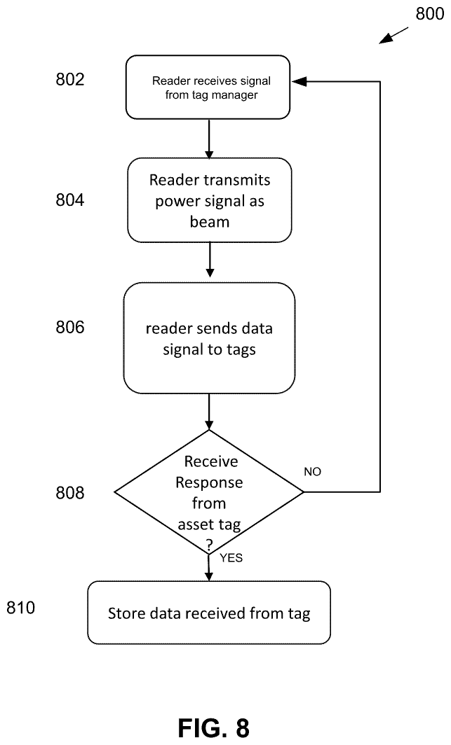

FIG. 8 illustrates a method 800 performed by a reader in accordance with the method of the present disclosure. Initially, the reader receives a signal from the tag management module 104 based on a request for data or based on a schedule (STEP 802).

The one or more signals cause the one or more readers 106 to scan for the one or more tags 108 by transmitting the power signal in accordance with scan pattern information provided to the waveform generators 631 in each channel processor 630 of the wireless power transmitter 506 (STEP 804). The power signal provides enough power to any tags 108 in range to allow the tags 108 to operate.

The reader 106 sends a data signal to any tags 108 in range (STEP 806). In some embodiments, in contrast to the power signal, the data signal is not transmitted using a phased array antenna. Furthermore, the data signal may be transmitted at a frequency that is different from the frequency of the power signal. In some embodiments, the power signal is transmitted at a higher frequency. In some embodiments, the data signal is transmitted on a periodic basis so that when a tag 108 receives power from the power signal, the data signal will be transmitted shortly thereafter.

If the reader 106 receives the retransmission of the data signal from a tag 108 (STEP 808), the read 106 provides stores the information locally and provides the information to the tag management module 104, which in some embodiments, sends data to the asset management module 102.

FIG. 9 illustrates a flowchart 900 of an embodiment of a method for operating the system of FIG. 3. Initially, an external client 320, 322 or EMW API 324 sends a request (e.g., via the RESTful API 314, the UI 316, or the tRFC 318, respectively) to the API 308 (STEP 902). The routing of the request depends on the type of request made (STEP 904). In some embodiments, the external client interface 312 is configured in one of the following ways: a RESTful API (a Representational State Transfer API) 314, a UI (User Interface) 316, tRFC (transport Radio Frequency Communication) 318 or a custom transport layer. In some embodiments, the custom transport layer is configured as an interface for a specific software application. In some embodiments, the hardware agent 311 is coupled to the API 308 (allowing an external agent to control the hardware agent 311). The hardware agent 311 monitors and communicates with a collection of firmware-related software units that are developed and updated together. In some embodiments, external client 320 communicates with the API 308, via RESTful API 314, and external client 322 communicates, via UI 316. EWM (Engineering Workflow Management) API 324 communicates, via tRFC 318.

If the request is for data, the API 308 sends the request to the asset database 304 (STEP 906). Then, the data is retrieved from the asset database 304 (STEP 908). If the request is to modify the scan schedule, the parameters of the ML/AI chain 306 or for the ML/AI algorithm to perform a task, then the request is sent to ML/AI chain 306 (STEP 910), and an instruction to fulfill the request is implemented (STEP 912).

If the request is to directly access data from one of the tags 108, then the request is sent to the hardware agent 311, the hardware agent 311 instructs one of the readers 106 to send communications to one of the tags 108 (STEP 914). A response including asset data from the tag that was queried is received at the long-range tag reader and relayed via the hardware agent 311 and the API 308 and one of the RESTful API 314, the UI 316 or the tRFC 318, to the client making the request (STEP 916).

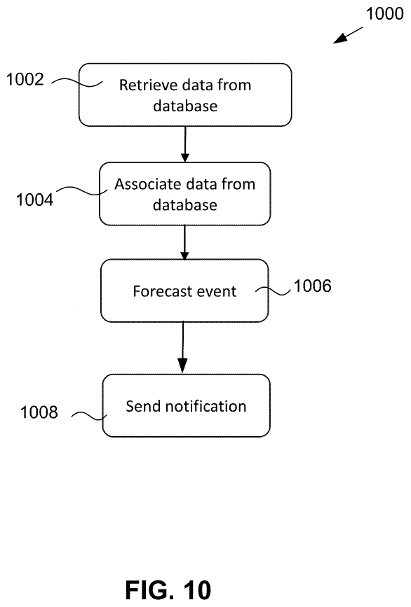

FIG. 10 illustrates a flowchart of an embodiment of a method implemented by FIG. 4. Initially, data is retrieved from the asset database 304 (STEP 1002). Data from the database is associated with the tags (STEP 1004). Events are then forecast (STEP 1006). Notifications are then sent to users regarding the events predicted and the parameters of the algorithms that govern procurement policies are adjusted (STEP 1008).

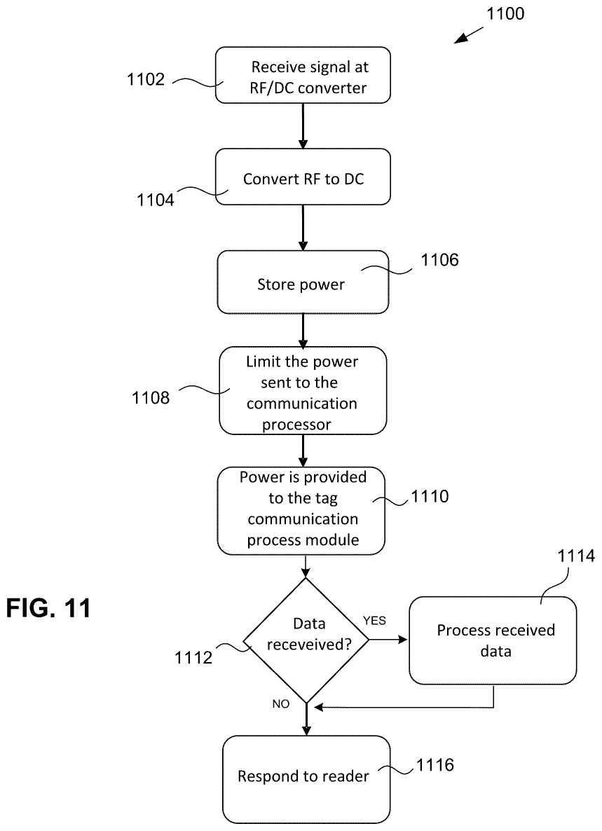

FIG. 11 illustrates a flowchart of a method 1100 of the operation of tags 108 (see the discussion of FIG. 7). An RF signal is received at RF-DC converters 710 within the wireless receivers 708 of tag 108 (STEP 1102). The signal is then converted to DC (STEP 1104). The signal is sent from the wireless power receiver channel 708 to the storage capacitor 706 (STEP 1106) and stored. The amount of power released from the storage capacitor 706 is limited by OVP 704 (STEP 1108). Power is provided to the tag communication process module 702. (STEP 1110). The tag communication process module 702, upon receiving power, determines whether data has been transmitted to the tag 108 (STEP 1112). If so, the data is processed (STEP 1114) and a response is transmitted to the reader 106 (STEP 1116). If not, then a response is sent to the reader 106 (STEP 1116) without the need to process data.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain method steps and certain apparatus components can be altered without substantially impairing the functioning of the invention.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the description provided.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A long-range asset tag comprising:
a) a wireless power receiver configured to receive an unmodulated power signal and convert the unmodulated power signal to a direct current power output; and
b) a tag communication process module coupled to the wireless power receiver to receive power from the wireless power receiver and in response, to provide an output signal for transmission to a long-range tag reader from which the unmodulated power signal was transmitted.

2. A long-range asset tag reader (hereafter “reader”) comprising:
a) a wireless power transmitter configured to transmit an unmodulated power signal;
b) a plurality of transmit elements, the transmit elements being coupled to the wireless power transmitter and being configured to receive a plurality of unmodulated power signals from the wireless power transmitter, the plurality of unmodulated power signals to be transmitted through the plurality of transmit elements, the relative phase of the plurality of unmodulated power signals determining the characteristics of a signal to be transmitted; and
c) a data receiver configured to receive a data signal transmitted by a long-range asset tag in response to the transmission of the plurality of unmodulated power signals.

3. The reader of claim 2, further comprising:
a) a tag management communication interface configured to receive a scan schedule; and
b) a reader communication module coupled to the tag management communication interface and to the wireless power transmitter, and configured to receive the scan schedule and provide the scan schedule to the wireless power transmitter.

4. The reader of claim 3, wherein the reader communication module comprises:
a) a reader communication processor; and
b) a data transceiver, the data transceiver comprising the data receiver.

5. The reader of claim 4, wherein the data transceiver is implemented by the reader communication processor.

6. The reader of claim 4, wherein the wireless power transmitter comprises:
a) an application processor configured to receive the scan schedule and generate signals to control characteristics of the plurality of unmodulated power signals to form a beam to focus energy of an unmodulated composite power signal in a desired direction resulting from the transmission of the plurality of unmodulated power signals in the desired direction; and
b) a plurality of wireless power transmitter channels coupled to the application processor and configured to receive the signals generated by the application processor, each of the plurality of wireless power transmitter channels coupled to a corresponding one of the plurality of transmit elements to the corresponding transmit element with the unmodulated power signal to be transmitted through that corresponding transmit element.

7. An asset management system comprising:
a) an asset management module, comprising:
i. a hardware agent configured to receive asset data, including information regarding the presence of assets and the nature of the assets;
ii. an association analysis module configured to receive asset data and to analyzes associations between the asset data to discover patterns and associations; and
iii. a predictive analysis module coupled to the association analysis module and configured to perform predictive analysis based on input received from the association analysis module and to determine at least one of the ways assets from which the asset data was attained are to be (1) transported, (2) stored and (3) consumed, based on the input received from the association analysis module.

8. The asset management system of claim 7, further comprising;
a) a reader having:
i. a wireless power transmitter configured to transmit an unmodulated power signal;
ii. a plurality of transmit elements coupled to the wireless power transmitter and being configured to receive a plurality of unmodulated power signals from the wireless power transmitter, the plurality of unmodulated power signals to be transmitted through plurality of transmit elements, the relative phase of the plurality of unmodulated power signals determining the characteristics of a signal to be transmitted; and
iii. a data receiver configured to receive a data signal in response to the transmission of the plurality of unmodulated power signals;
iv. a reader communication processor coupled to the asset management module and configured to transmit asset data received on the data signal to the asset management module; and
b) a long-range asset tag having:
i. a wireless power receiver configured to receive an unmodulated power signal from the wireless power transmitter and convert the unmodulated power signal to a direct current power output; and
ii. a tag communication process module coupled to the wireless power receiver to receive power from the wireless power receiver and to provide data for the data signal for transmission to the long-range Tag Reader, the data providing the received information to the asset management module.

9. The asset management system of claim 7, wherein the asset management module resides in a cloud, such that it is accessible to users to access information regarding the long-range asset tags.

10. The asset management system of claim 9, wherein the asset management module automates asset procurement policies using predictive analytics.

11. The asset management system of claim 9, wherein the asset data includes information regarding the beam direction at the time the asset data was received.

12. The asset management system of claim 9, wherein the asset management module manages a scan schedule that controls scanning of power signals transmitted by the reader.

13. The asset management system of claim 7, further comprising a tag management module coupled between the asset management module and the reader, the tag management module configured to manage the scan schedule.

14. The asset management system of claim 7, further comprising a tag management module coupled between the asset management module and the reader, the tag management module configured to filter out duplicate asset data received by the readers.
